(19) United States
(12) Patent Application Publication
(10) Pub. No.: US 2005/0010593 A1
(43) Pub. Date: Jan. 13, 2005

(54) System and method for performing predictive file storage management

(75) Inventors: Craig Fellenstein, Brookfield, CT (US); Carl Phillip Gusler, Austin, TX (US); Rick A. Hamilton II, Charlottesville, VA (US); James Wesley Seaman, Falls Church, VA (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/617,524

(22) Filed: Jul. 10, 2003

(51) Int. Cl. G06F 17/00

(52) U.S. Cl. 707/104.1

(57) ABSTRACT

The present invention provides a method and system for storing information into a folder/location using a predictive function to select the name for the newly stored information. The predictive functions use names of applications, documents or words within these items to select and present a name to a user. The present invention introduces a new function within document processing applications, (also potentially operating systems), whereby each time a document is saved to a storage medium, a predictive function will cause the selection of the most probable folder/location in which the document would be stored.

### FIELD OF THE INVENTION

The present invention relates to a method and system for managing files within a computing system or network and in particular to a method and system for predicting the storage location of a file or other information for the purpose of storing or retrieving that information at a later time. The prediction of a file storage location can be based on a name or content of a particular file.

### BACKGROUND OF THE INVENTION

Today, there are numerous devices used to create a multiplicity of electronic documents. These documents include conventional word processing documents, scanned materials, e-mail messages, e-mail messages containing attached documents, and faxed documents. For most people, conventional word processors are used to create electronic documents. With theses word processors, the easiest way to prepare a document is to simply enter text as if typing on a typewriter. The average user often relies upon his/her familiarity with the keys on a typewriter to prepare a document using a word processor. Today's word processing software enables even inexperienced users to prepare sophisticated documents. Word processors typically include a number of features that allow the user to format a document by defining the style, layout, or character font(s) of a document. Using these features, the user can create a variety of documents such as reports, letters, memos, etc. having different layouts, fonts, styles, etc.

Once the user has finished creating the document, the user typically saves the document in a file and stores the file at some storage location on the computer's hard drive, on an inserted floppy disk, compact disc, external/internal disk storage device, or to a magnetic tape. In a conventional file storage operation, the user will need to identify the storage medium and location for the created file. Depending on the configuration of the user's computer system, the storage medium could be related to a single machine or it could be a storage medium incorporated into a multiple machine storage configuration such as a grid of many machines across a grid-computing network. In an example, using a document created in a “WORD” word processing program, there are some typical steps to save and store. Initially, the user will click the “save as or save” icon to indicate to the word processing program that the user is ready to store the document. The program gives the user the opportunity to give the document a file name. The program also displays a default storage folder location. The default folder can be a designated default folder or it can be the folder of the last document created or modified by the user. If this folder is acceptable to the user, the user can click the save icon and the file will be saved into that folder location and under the file name assigned to it by the user.

If the user does not want to save the document in the default folder or any machine in a grid-computing network, the user must indicate the storage location for the document. In this process, the user will navigate through the directory on a single machine or grid on a computing network to arrive at a desired storage location. When the user finds the desired storage location, the user then clicks the save icon and the document is stored in that location under the file name the user gives to the document. The process of navigating through the system directory or grid network creates a file path that is used to locate the file containing the document when the user desires to retrieve the document at a later time.

In the event, the user receives an e-mail containing an attached file, if the user wants to download and store that file in a storage location, the user follows basically the same above-described file storage procedure. Scanned documents are stored in a similar manner to created documents.

As mentioned, current word processing applications require manual path management, if a file is to be saved or detached into any location other than the default folder. In addition, more often than not, the default folder is not the desired storage location for a current file, thus, there must be a manual operation for selection of a storage location. As an example, the default behavior of many systems is to attempt to save a file into some folder such as “Recent Documents,” i.e., a holding-pen for any recent activity. Correcting this storage behavior is both time-consuming and error prone. Therefore, there remains a need for a method and system to store and retrieve files that is less tedious and more efficient than current file storage techniques. One such solution could be an automated and predictive storage system to store and retrieve files. Such a system would provide greater productivity and utilization enhancements to the user interface.

Currently, some automated document retrieval systems do exist. In a document retrieval system, which handles an enormous amount of documents, a retrieval method using keywords, is generally adopted. In this process, an arbitrary keyword (retrieval word) is inputted into the retrieval system as a retrieval condition. The resulting search retrieves all files containing that keyword in their contents are obtained as a result of retrieval. The file retrieval process according to this method is called a full text search. An example of this type of system is the patents database at the United States Patent and Trademark Office (USPTO). When a user desires to search for a particular patent, the user will input a certain keyword that will be used to conduct the search. In addition, the user can designate the location in the patent for the search to occur. The USPTO provides the capability to search the title, abstract or other specific keywords in the patent document such as by the inventor or an assignee. This particular approach works well for retrieving previously stored files, however, a system for storing files may prove to be more challenging task.

Another widely used method is one in which one or more keywords for retrieval are added to each file name in advance and the file name having the keywords one of which matches an inputted retrieval word is regarded as a result of retrieval. In addition, these current systems focus on file retrieval, but there still remains a need for an automated system that can accurately predict and store files in accordance with the desires or semantic heuristics defined by the user. Semantic heuristics are defined as a rule for a string or set of constraints combined by a pattern of words or symbols in a given language.

### SUMMARY OF THE INVENTION

It is an objective of the present invention to provide a method and system for storing information into a location using a predictive function to select the name and storage location of the newly created or modified information.

It is a second objective of the present invention to provide a method and system to determine a storage location for a file based on a name or semantic heuristics of the file.

It is a third objective of the present invention to provide a method and system to retrieve a file or information from a storage location based on content information in the file.

It is a fourth objective of the present invention to provide correlations between the name of a file and the identity of a location in a computer system or grid computing network in order to facilitate efficient and predictive storage and retrieval of files.

The present invention provides a method and system for storing information in a location using a predictive function to select the name for the newly stored information. The predictive functions use names of applications, documents or words within these items to select and present a name or symbolic language pattern to a user.

The present invention solves the problem of lost time and efficiency involved in storing files from any number of word/document processing applications. It does so by establishing correlations between the name of the current file and the identities of locations on the computer system or grid-computing network, and then offers a possible default directory/location into which the current file might be stored.

The present invention introduces a new function within document processing applications, (also potentially operating systems and/or grid computing), whereby each time a file is stored, a predictive function will cause the selection of the most probable folder or other location in which the document would be stored. As an example, if a user has a folder named “ACME Computers” and the user is storing a file named “ACE Service Contract” from a word processing application or is detaching a file from an electronic mail application, the predictive element of the present invention would select the “ACME Computers” folder location as the storage location for the file named “AME Service Contract”. In addition, if the folder or location names fail to meet the predictive criteria, the individual file names contained within the folders or identified storage locations could provide second level predictive values. Furthering the previous example, if some of the files stored within the “ACME Computers” folder location begin with the initials AC, (AC Service Contract, for example), and the user saves or detaches a document beginning with the initials “AC”, again, the “ACME Computers” folder location would be selected as the storage location.

In the event the user misspells a storage location name, the search will not find the designated storage location. The user will have the opportunity to redefine the storage location.

### DESCRIPTION OF THE DRAWINGS

FIG. 1 is a conventional computing device used for communication in a computing environment.

FIG. 2 is a flow diagram of the general method for implementing the concepts of the present invention.

FIG. 3 is a flow diagram of the steps in the implementation of a method of the present invention wherein the method has a user override capability.

FIG. 4 is a flow diagram of the steps in the implementation of the method of the present invention wherein the method has a default storage location option.

### DETAILED DESCRIPTION OF THE INVENTION

The present describes the implementation of a method and system for managing the storage of information. This method and system can be implemented on any computing device, in any computing configuration and any context where information is created and stored in a designated memory location. However, for the purpose of explaining and illustrating the concepts of the present invention, the implementation of the present invention will be described using a conventional personal computing system Notwithstanding the description in terms of a conventional computer, the concepts of the present can also be implemented with other devices such as palm pilots and cellular telephones. In addition, the type of information stored can vary from programs, text, photographs and/or images, audio stream files, to graphics files. The memory location for storage can be physical or virtual. In a case of a virtual location, such as in RAM, the storage location does not sit on a physical platform. In addition, a physical location could be anywhere on a computing network environment.

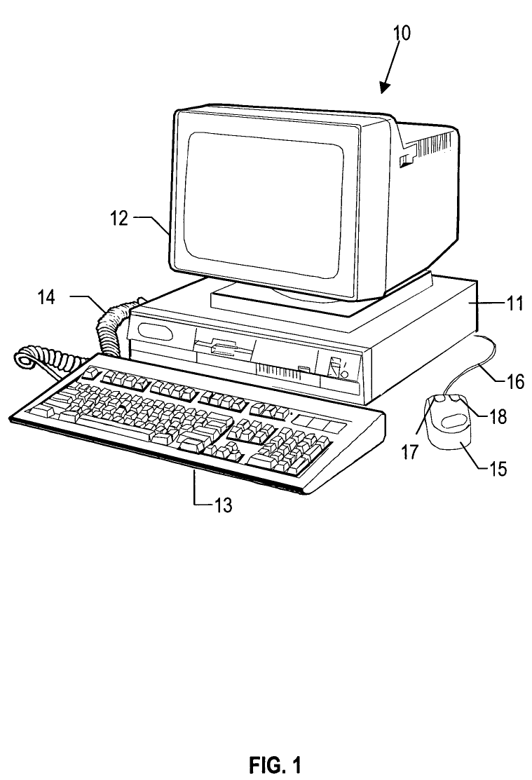

With reference now to FIG. 1, there is depicted a pictorial representation of conventional computing device 10 which may be used in a type of implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those of the present invention may be implemented utilizing a personal computer 10. {However, as previously mentioned, the concepts of the present invention can be implemented on any computer storage device, not just those with keyboards, tethered by cords with typical screens.

Within a storage location in a computing environment, there can be a physical hierarchical storage system or there can be other systems such as massively parallel, or virtual grid memory schemes. For purposes of this description, the primary method for containing information is in a file. Files can have a variety of formats. In the example using the device of FIG. 1, and using an MS Windows operating system, files are stored in physical locations called folders. In other operating systems, such as Unix, or AIX the storage configuration, terminology and storage means may differ. The user can create folders or a system programs can create the folders. In addition, a folder can contain other folders as part of a hierarchical information storage system. As a result of the variety of storage options, there can be a series of folder and folder locations from which a user may choose to store a file. The eventual storage location can be identified by a path name to that location. This path name will contain each folder and sub-folder accessed in the process of accessing the storage location of a document.

Because of the variety of storage options, the present invention uses predictive analysis techniques to determine the storage location of files and other documents within this system. Predictive analysis is a maturing and ever more reliable art, and when applied to file processing applications as discussed within this description, provides for an excellent functional and efficiency enhancement to existing application storage procedures. It should be noted that this predictive functionality could be embedded in either the file processing application itself, or equally, within the underlying operating system's file management code. Optionally, this functionality could be added to a computing environment via a stand alone “File Management Application”. It should also be noted that the predictive techniques used could vary greatly based on application characteristics, and are not limited to those sighted as examples within this disclosure. The following description will give practical examples of how this functionality could operate. It should be noted that many implementation specifics are possible and the invention is not limited to the illustrations described herein.

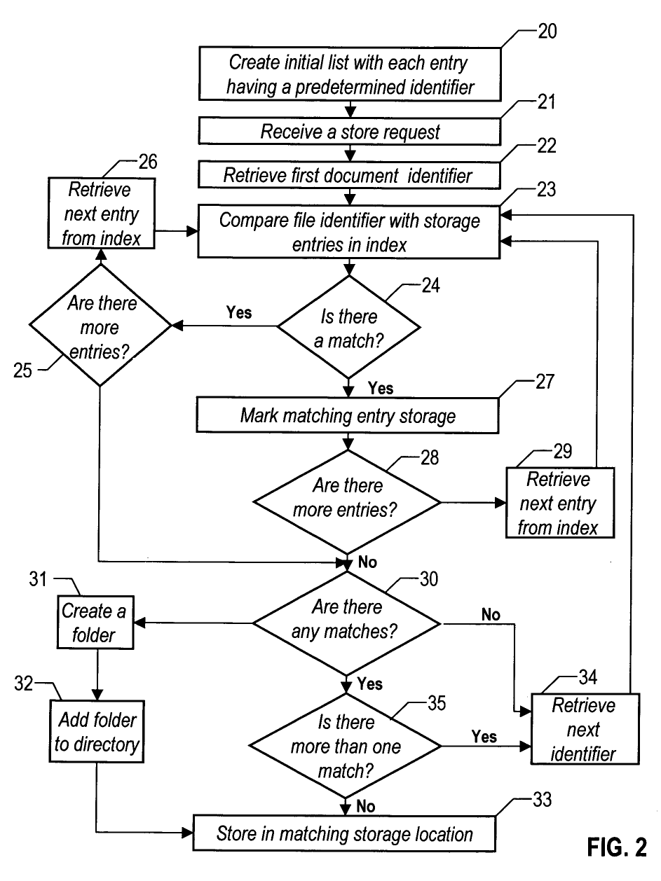

FIG. 2 illustrates a flow diagram of the general method for implementing the concepts of the present invention in accordance with the device illustrated in FIG. 1 and an MS Windows operating system. In the process of predicting the storage location for a file, there are four basic scenarios. The first scenario is when the predictive process finds one storage location entry matching the search criteria for storing the file. The second scenario is when the predictive process finds multiple storage location entries that match the search criteria for storing the file. The third scenario is when no matches are found for the search criteria. The fourth scenario is when the user has a specific location where they want to store a particular file. In this fourth scenario, the user can override the predictive process of the present invention.

For purposes of the description of the invention, all storage materials including word processing documents, e-mail documents, scanned and faxed documents, audio stream files and/or virtual memory streams, pictures, images and graphics will be referred to as files. The process of the present invention can be incorporated into the operating systems of a computer, and/or into the word processing application running on a computer, and/or into a web browser. Referring to FIG. 2, the initial task in step 20 is to create a list of storage location entries for which a user may store files. Each storage location will be an entry in this list. This list can have an index of the storage locations with a predetermined identifier for each location. The process of creating this list of storage locations can vary for the user in the predictive process of the present invention.

In a typical situation, a user may be in the process of creating a new document. The user has completed work on the document and/or desires to store the document. As mentioned, the document would be stored as a file and in this example stored according to a name given to it by the user.

In the process of the present invention, the user would click the save option. As a result, the process would receive a save request indicating that the user is ready to store the document, step 21. The process would access the index created in step 20 containing the storage locations. The process would also retrieve the first storage location identifier that will be used to designate and predict the storage location of the file, step 22. The process of retrieving the storage location identifier can also vary. The user may be prompted to enter a file name. For example, the user may name the file ACME Inventory. From this name, the storage location identifier would be the first word, ACME. Another option would be to use the first characters of the document. Again, if the title of the document were ACME Inventory, the first location identifier would be the first set of characters or the first word, ACME. However, for some types of files, the use of document characters may not be practical or available. In those cases, it would be necessary to generate another type of identifier.

Step 23 compares the first identifier with the folder names in the index. As previously mentioned, these storage entities could be a collection of folders in a file storage system. In this process, there can be a one-to-one comparison of the storage identifier to each storage entry in the index. Step 24, makes a determination whether there is a match between the first identifier and each storage location entry. If there is not a match between a particular storage location entry and the first identifier, the process moves to step 25 where there is a determination of whether there is another entry in the index. The purpose of step 25 is to make sure that the first identifier has been compared with each entry in the index before proceeding to the next phase of the process. If the determination is that there are more entries in the index, step 26 retrieves the next entry in the index. The process then returns to the comparison step 23.

Referring again to step 24, if there is a match between the first identifier and a particular storage entry name, the process moves to step 27 where the matching entry is marked in the index for referral later in the process. One marking scheme may be to create an index to the particular storage location. Another marking scheme could be to create a matching entry list that identifies each storage entry that matches the first identifier. After a matching storage entry is marked, step 28 makes a determination of whether there are any more entries in the index. This step performs the same function as step 25 to make sure that all of the entries in the index have been considered before the process moves to the next phase. If the determination is that there are more entries in the index, step 29 retrieves the next entry in the index. The process then returns to the comparison step 23.

Step 30 begins another phase of the process of the present invention. At this point, there has been a comparison of the first identifier with each entry in the index. Step 30 makes a determination of whether there are any entries that match the first identifier. As shown in FIG. 2, step 30 can be reached from step 28 or step 25. Because step 26 can go to step 30, there is the possibility that no entries in the index that match the first identifier. As a result, it is necessary to perform step 30 in this process. If the determination in step 30 is that there are no entries that match the first identifier, the process can move to step 31 where the new folder or other storage location is created for the file. This storage location would then be given a name and added to the storage location index in step 32. The new storage location name could be based on the name of the newly created document. After the creation of the storage location, the file would then be stored in that location in step 33. Another option, when there is a determination that there are no matches, is to retrieve another identifier in step 34 and then return to step 23 to perform a comparison of the matching entries from the previous comparison using the next identifier.

Referring to step 30, if the determination is that there is a match between the first identifier and one or more entries in the index, step 35 makes a determination of whether there are more than one matching entry. In the case, where there is only one match, the process would simply move to step 33 and store the file in the location of the matching entry. At this point, the process of the present invention would have predicted the storage location of a document and stored the document in that folder location.

In the event step 35 determines that more than one entry matched the first identifier, it would be necessary to distinguish which of the matching entries is the desired storage location. The possibility of multiple matches is quite common. Again using the ACME example, there could multiple ACME folders, such as ACME Agreements, ACME Orders, ACME Shipments, and ACME Invoices. In a search using ACME as the first identifier, each ACME folder would be a match and each ACME folder would be marked in step 27. As shown in FIG. 2, in the case of multiple folder matches, one solution would be to go to a second folder identifier. Step 34 would retrieve this second or next identifier. After retrieving this next identifier, the process would return to the comparison step 23. During this comparison round, the retrieved identifier would be compared to the matching entries from the first comparison. The process would proceed in the same manner as the first pass using the next identifier, but only with the matching entries from the first comparison.

The process for determining the next modifier could also vary. One approach could be to use the next word or characters from the current document. A second approach could be to have a hierarchy of the matching storage entries such that a key word or character from one of the entries is designated as the identifier. A third approach is to have input from the user. In any event, if the next identifier was ‘orders’, the process would produce a match with the folder ACME Orders. At this point, the process would select the ACME Orders folder for storage of the current file.

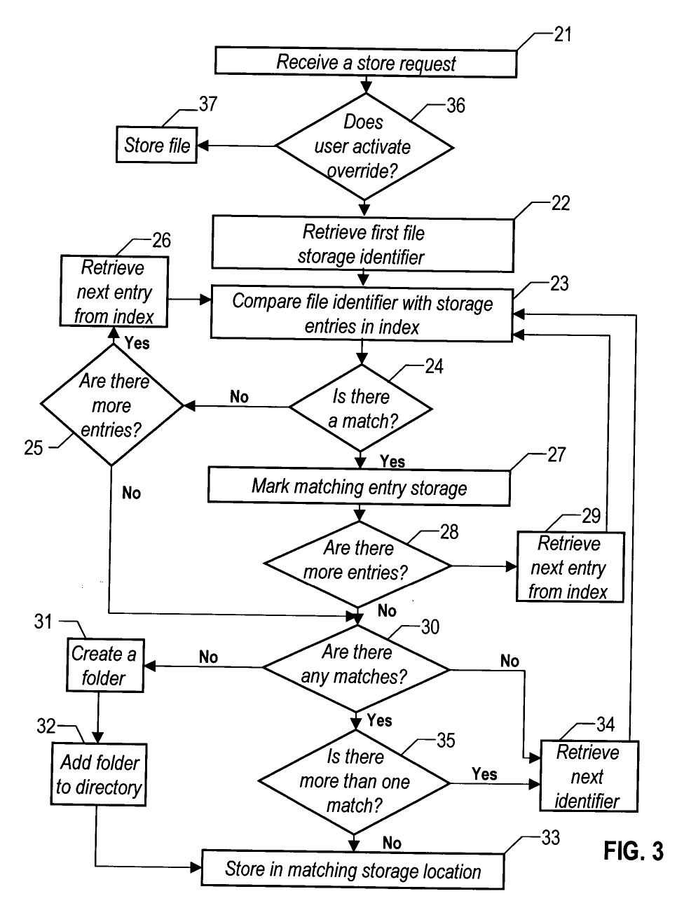

FIG. 3 provides an additional option to the process of the present invention. This option would give the user an opportunity to override the process of the present invention and manually chose the storage location of the file. The use of this override process would result in the current conventional manual storage process. However, the user should always have the option to select the storage location for the information. Referring to FIG. 3, after the process receives a save request in step 21, the user could receive an override query from the process in step 36. If the user chooses to activate the override option, the process moves to step 37 and the user would then identify the storage location for the file. In addition, if the user chose to activate the storage option, the process of the present invention would terminate. If in step 36, the user chose not to activate the override option, the process would proceed to step 22 as previously described in FIG. 2.

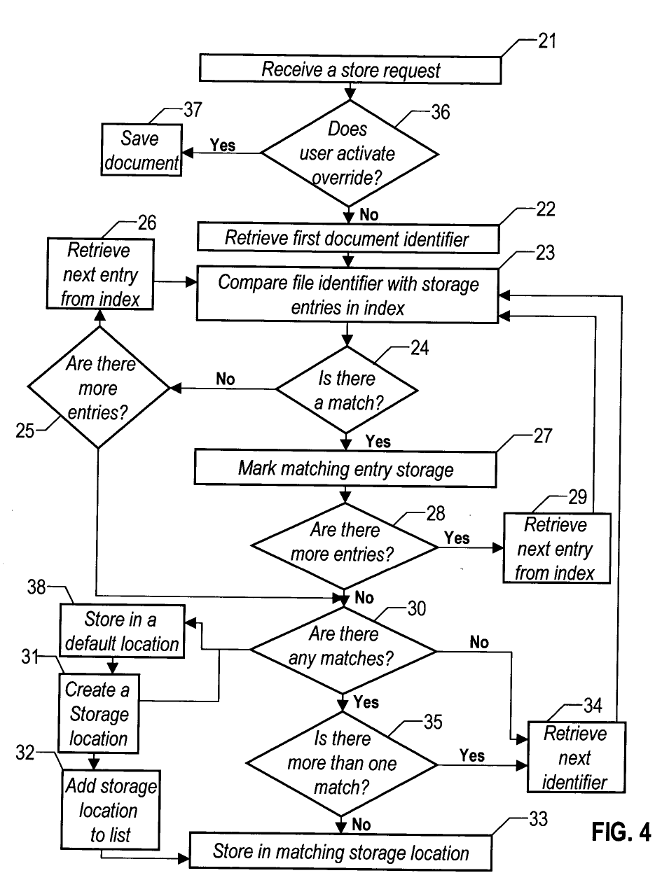

Referring to FIG. 4, still another option is available during the process of the present invention that will account for the scenario when there is a determination in step 30 of no matches. As shown in FIG. 4, there is an option of storing the file in a default storage location in step 38. Again as with the user override option of step 36, the user may be involved in this determination. As described, step 30 can produce at least four different alternatives. In a likely embodiment, a logic analyzer could run through the possible alternatives in real-time to produce the desired decision based on certain inputs into the logic analyzer.

In the process of the present invention, an approach to implementing a default option in step 37 could be to select the last accessed directory as the default storage location. This approach is typical behavior for most legacy applications. However, this method is particularly undesirable when detaching files from collaborative applications such as electronic mail and instant messaging in that when storing and detaching the many files received every day, it is very unlikely that the current file will be related to either the preceding or following files. Some other applications select a single default folder as a storage location. Again, this is not desirable, in that most users like to segregate their documents by content, and not be the application with which the document was created. As an example, if a user creates a spreadsheet outlining financials for a particular client, in all likelihood, the user would want to save the file containing this document in the client folder, and not in the default folder of the spreadsheet application. Finally, some older and less sophisticated applications simply select a default media, such as the computers “A:\drive” as the default storage location. Each of these methods is very inefficient and requires the user to navigate to the correct directory for each save/detach function.

Referring to steps 28, 29 and 30, in FIG. 4, if there is no match between the storage identifier and a storage location entry, further analysis can be made based on file name to file name matching (again, directory or via index table). This process may entail moving from a more-desired criterion down to lesser-desired criteria. For instance, if no first-word-match is made, then a letter-sequence-match may be attempted. Optimally, the user will have the option to specify which directories would be candidates for storage, such that an undesired directory, e.g., a device driver directory, may not be considered a match candidate.

As previously mentioned, the present invention is described using conventional well-known devices for the purpose of explaining the concepts of the invention. These concepts can be implemented in any device with information storage capabilities. As a result, the present invention can have numerous implementations and configurations. These implementations would all be within the concept described herein. It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A method for predicting the storage location of file comprising the steps of:
retrieving an identifier for the file for which predictive storage is desired;
comparing the retrieved identifier with a set of file storage locations in a storage index;
determining whether there is a match between a retrieved identifier and a storage location from the storage index; and
storing the file in the storage location matching the retrieved storage identifier.

2. The method as described in claim 1 further comprising before step 1 the step of creating an initial storage index wherein each storage location entry in the index has a predetermined identifier.

3. The method as described in claim 2 further comprising after said match determination step, the steps of:
marking a storage entry having an identifier that matches the file identifier;
determining whether there are more storage entries in the index to compare with the identifier of the file to be stored;
determining whether there are any marked entries, when there is a determination that there are no more entries in the index to compare with the file identifier;
determining whether there is more than one entry matching the file identifier, when there is a determination that there are marked entries in the index; and
storing the file in the storage location with the matching identifier when there is only one storage entry matching the file identifier.

4. The method as described in claim 2 further comprising after said match determination step, the steps of:
marking an entry having an identifier that matches the file identifier;
determining whether there are more entries in the index to compare with the identifier of the file;
determining whether there are any marked entries, when there is a determination that there are no more entries in the index to compare with the file identifier;
determining whether there is more than one entry matching the file identifier, when there is a determination that there are marked entries in the index;
retrieving a next file identifier when there is determination of more than one marked entry in the index; and
returning to said comparison step.

5. The method as described in claim 2 further comprising after said match determination step, the steps of:
marking an entry having an identifier that matches the file identifier;
determining whether there are more entries in the index to compare with the identifier of the file;
retrieving a next file identifier and a next entry identifier for a marked entry; and
returning to said comparison step.

6. The method as described in claim 2 further comprising after said match determination step, the steps of:
marking an entry having an identifier that matches the file identifier;
determining whether there are more entries in the index to compare with the identifier of the document;
determining whether there are any marked entries, when there is a determination that there are no more entries in the index to compare with the file identifier; and
creating a new storage location in which to store the file when there is a determination that there are no entries matching the file identifier.

7. The method as described in claim 6 further comprising the step of adding the newly created storage location to the storage location index.

8. The method as described in claim 2 wherein said wherein said match determination step further comprises the step of determining whether there are more entries in the index when there is a determination that there is not a match between the file identifier and an entry in the index.

9. The method as described in claim 8 further comprising the step of retrieving the next entry from the index when there is a determination that there are more entries in the storage location index and returning to said comparison step.

10. The method as described in claim 2 wherein said wherein said match determination step further comprises the steps of:
determining whether there are more entries in the index when there is a determination that there is not a match between the file identifier and an entry in the index;
determining whether there are any marked entries, when there is a determination that there are no more entries in the index to compare with the file identifier;
determining whether there is more than one entry matching the file identifier, when there is a determination that there are marked entries in the index; and
storing the file in the storage location with the matching identifier when there is only one storage location entry matches the file identifier.

11. The method as described in claim 2 further comprising after said match determination step, the steps of:
marking a storage location entry that matches the file identifier;
determining whether there are more entries in the index to compare with the identifier of the file;
determining whether there are any marked entries, when there is a determination that there are no more entries in the index to compare with the file identifier; and
storing the file to a default storage location when there is a determination that there are no entries matching the file identifier.

12. The method as described in claim 2 further comprising after said match determination step, the steps of:
marking a storage location entry that matches the file identifier;
determining whether there are more entries in the index to compare with the identifier of the file;
determining whether there are any marked entries, when there is a determination that there are no more entries in the index to compare with the file identifier; and
retrieving a next file identifier and a next matching entry and returning to said comparison step, when there is a determination that there are no storage entry identifiers matching the file identifier.

13. The method as described in claim 2 further comprising before said identifier retrieval step, the step of receiving a store file request.

14. The method as described in claim 2 further comprising before said identifier retrieval step, the step of determining whether there is an activated user override and storing the file as designated by the user when there is a determination of an active user override.

15. The method as described in claim 2 wherein the storage location identifier is a string of words.

16. The method as described in claim 2 wherein the storage location identifier is a string of characters.

17. The method as described in claim 2 wherein the storage location identifier is one word.

18. A computer program product in a computer readable medium for performing predictive file storage of a file comprising:
instructions for retrieving an identifier for the file for which predictive file storage is desired;
instructions for comparing the retrieved identifier with a set of storage location entries in a storage index;
instructions for determining whether there is a match with a storage location identifier from the storage index; and
instructions for storing the file in the storage location matching the retrieved file identifier.

19. The computer program product as described in claim 18 further comprising before said identifier retrieval instructions, instructions for creating an initial storage location index wherein each entry in the index has a predetermined storage location identifier.

20. The computer program product as described in claim 19 further comprising after said match determination instructions:
instructions for marking an entry having an identifier that matches the file identifier;
instructions for determining whether there are more entries in the index to compare with the identifier of the file;
instructions for determining whether there are any marked entries, when there is a determination that there are no more entries in the index to compare with the file identifier;
instructions for determining whether there is more than one storage entry matching the file identifier, when there is a determination that there are marked entries in the index; and
instructions for storing the file in the storage location with the matching identifier when there is only one storage entry identifier matching the file identifier.

21. The computer program product as described in claim 19 further comprising after said match determination instructions:
instructions for marking an entry having an identifier that matches the file identifier;
instructions for determining whether there are more entries in the index to compare with the identifier of the file;
instructions for determining whether there are any marked entries, when there is a determination that there are no more entries in the index to compare with the file identifier;
instructions for determining whether there is more than one storage location matching the file identifier, when there is a determination that there are marked entries in the index;
instructions for retrieving a next file identifier to compare with the entries matching the previous file identifier; and
instructions for returning to said comparison instructions.

22. The computer program product as described in claim 19 further comprising after said match determination instructions:
instructions for marking an entry having an identifier that matches the file identifier;
instructions for determining whether there are more entries in the index to compare with the identifier of the document;
instructions for retrieving a next file identifier; and
instructions for returning to said comparison instructions.

23. The computer program product as described in claim 19 further comprising after said match determination instructions:
instructions for marking an entry that matches the file identifier;
instructions for determining whether there are more entries in the index to compare with the identifier of the document;
instructions for determining whether there are any marked entries, when there is a determination that there are no more entries in the index to compare with the file identifier; and
instructions for creating a new storage location in which to store the document when there is a determination that there are no entries matching the file identifier.

24. The computer program product as described in claim 23 further comprising instructions for adding the newly created storage location to the storage location index.

25. The method as described in claim 19 wherein said match determination instructions further comprising instructions for determining whether there are more entries in the index when there is a determination that there is not a match between the file identifier and an entry in the index.

26. The computer program product as described in claim 25 further comprising instructions for retrieving the next storage location entry from the index when there is a determination that there are more entries in the storage location index and instructions for returning to said comparison instructions.

27. The computer program product as described in claim 19 wherein said match determination instructions further comprise:
instructions for determining whether there are more entries in the index when there is a determination that there is not a match between the file identifier and an entry in the index;
instructions for determining whether there are any marked entries when there is a determination that there are no more entries in the index to compare with the file identifier;
instructions for determining whether there is more than one folder matching the file identifier, when there is a determination that there are marked entries in the index; and
instructions for storing the file in identifier matching the file the matching storage location when there is only one storage location identifier.

28. The computer program product as described in claim 19 further comprising after said match determination instructions:
instructions for marking an entry in the index that matches the file identifier;
instructions for determining whether there are more entries in the index to compare with the identifier of the file;
instructions for determining whether there are any marked entries, when there is a determination that there are no more entries in the index to compare with the file identifier; and
instructions for storing the file to a default storage location when there is a determination that there are no entries matching the file identifier.

29. The computer program product as described in claim 19 further comprising after said match determination instructions:
instructions for marking an entry having an identifier that matches the file identifier;
instructions for determining whether there are more entries in the index to compare with the identifier of the file;
instructions for determining whether there are any marked entries, when there is a determination that there are no more entries in the index to compare with the file identifier; and
instructions for retrieving a next file identifier and returning to said comparison instructions, when there is a determination that there are no entries matching the file identifier.

30. The computer program product as described in claim 19 further comprising before said identifier retrieval instructions, instructions for receiving a store file request.

31. The computer program product as described in claim 19 further comprising before said identifier retrieval instructions, instructions for determining whether there is an activated user override and storing the file as designated by the user when there is a determination of an active user override.
